(19) United States
(12) Patent Application Publication
(10) Pub. No.: US 2014/0122047 A1
(43) Pub. Date: May 1, 2014

(54) APPARATUS AND METHOD FOR PREDICTING BOREHOLE PARAMETERS

(71) Applicants: Juan Luis Saldivar, Tomball, TX (US); Blake Burnette, Spring, TX (US)

(72) Inventors: Juan Luis Saldivar, Tomball, TX (US); Blake Burnette, Spring, TX (US)

(21) Appl. No.: 13/666,455

(22) Filed: Nov. 1, 2012

(51) Int. Cl. G06G 7/48

(52) U.S. Cl. 703/10

(57) ABSTRACT

A method of monitoring and predicting measurement data includes: collecting a first plurality of measured data values over an initial time interval; calculating an initial predictive model based on the initial measured data values and calculating a prediction of data values over a prediction time window based on the initial predictive model; collecting a second plurality of measured data values at a plurality of time values following the initial time interval; for each of the second plurality of time values, calculating a new predictive model based on: a data value at a current time value, the first plurality of measured data values, and measured data values associated with time values between the current time value and the initial time interval; and for each of the second plurality of time values, calculating a prediction of data values over a prediction time window based on the new predictive model.

### BACKGROUND

Many downhole operations used in hydrocarbon exploration and production involve effective fluid pressure management. For example, managed pressure drilling operations require fluid pressure management to maintain fluid pressures relative to a formation fracture pressure. Hydraulic stimulation operations, such as matrix stimulation and hydraulic fracturing, are used to improve productivity of hydrocarbon formations. In such operations, it is important to monitor fluid pressure to avoid undesirable pressure conditions such as over-pressure events.

### SUMMARY

A method of monitoring and predicting measurement data includes: collecting a first plurality of measured data values over an initial time interval; calculating an initial predictive model based on the initial measured data values collected during the initial time interval, and calculating a prediction of data values over a prediction time window beyond the initial time interval based on the initial predictive model; collecting a second plurality of measured data values at a plurality of time values following the initial time interval; for each of the second plurality of time values, calculating a new predictive model based on: a current measured data value at a current time value, the first plurality of measured data values, and measured data values associated with time values between the current time value and the initial time interval; and for each of the second plurality of time values, calculating a prediction of data values over a prediction time window beyond the current time value based on the new predictive model. In one embodiment, the method includes verification of the model.

An apparatus for monitoring and predicting measurement data includes: at least one sensor configured to measure a parameter; and a processor configured to collect a first plurality of measured data values over an initial time interval and collect a second plurality of measured data values at a plurality of time values following the initial time interval. The processor is configured to perform: calculating an initial predictive model based on the initial measured data values collected during the initial time interval, and calculating a prediction of data values over a prediction time window beyond the initial time interval based on the initial predictive model; for each of the second plurality of time values, calculating a new predictive model based on: a current measured data value at a current time value, the first plurality of measured data values, and measured data values associated with time values between the current time value and the initial time interval; and for each of the second plurality of time values, calculating a prediction of data values over a prediction time window beyond the current time value based on the new predictive model. In one embodiment, the apparatus is configured to perform a verification of the model.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 depicts aspects of a system for formation stimulation and hydrocarbon production;

FIG. 2 is a flow chart providing an exemplary method for monitoring and predicting measurement data;

FIG. 3 depicts curves representing an exemplary recursive model of fluid pressure during a downhole stimulation operation;

FIG. 4 is an illustration of an exemplary pump control monitoring and/or control device;

FIG. 5 depicts flow rate and fluid pressure data corresponding to an exemplary stimulation operation;

FIG. 6 depicts one of a plurality of predictive models generated during the operation of FIG. 5;

FIG. 7 depicts an exemplary predictive model generated at a time value corresponding to the onset of a fluid pressure step increase;

FIG. 8 depicts an exemplary predictive model generated at a time value corresponding to the onset of a fluid pressure peak;

FIG. 9 depicts an exemplary predictive model generated 13 seconds after the onset of the pressure peak of FIG. 8;

FIG. 10 depicts flow rate and pressure data and an exemplary predictive model at a first time value; and

FIG. 11 depicts exemplary predictive models generated at time values subsequent to the first time value of FIG. 10.

### DETAILED DESCRIPTION

Apparatuses and methods are disclosed for monitoring and/or analyzing data using predictive models based on measured data. A method includes generating a model based on initial measurement data and predicting future progression of the data over a selected prediction time interval. The model is updated or re-calculated, and a prediction is performed, at a plurality of subsequent consecutive times. The method may also include comparing each prediction to a threshold value, and triggering an alarm and/or some remedial action in response to predicted data values meeting or exceeding (or falling below) the threshold value within the prediction time interval.

Embodiments of the apparatuses and methods include management of downhole operational and/or measurement parameters such as fluid pressure and early detection of undesirable pressure events. A method for managing a downhole operation includes periodically or continuously monitoring a parameter such as fluid pressure (e.g., at surface and/or downhole locations), and generating a predictive model for detection of an event such as an over-pressure event prior to the onset of such an event. The method includes repeatedly updating or re-calculating a model, such as a recursive model, at selected times during a downhole operation. At each time, the model is used to predict the progression of pressure values over a prediction time interval or time horizon. If the modeled pressure exceeds a selected pressure value within the time horizon, a remedial action, alert or some other trigger may be generated to avoid the over-pressure event.

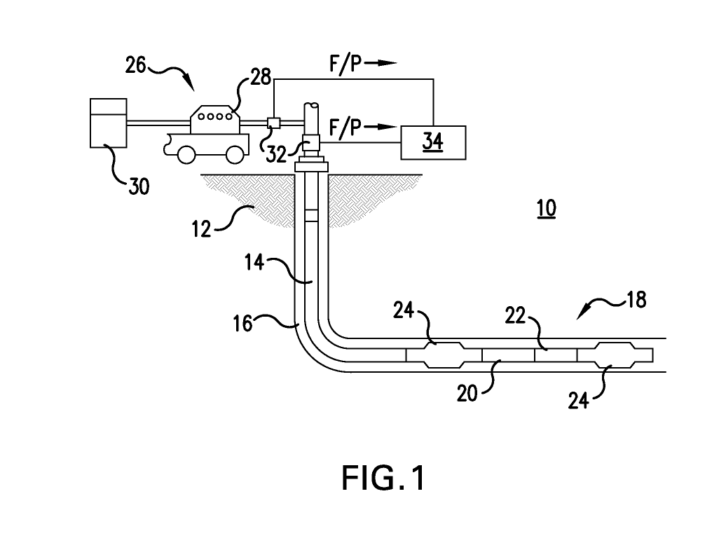

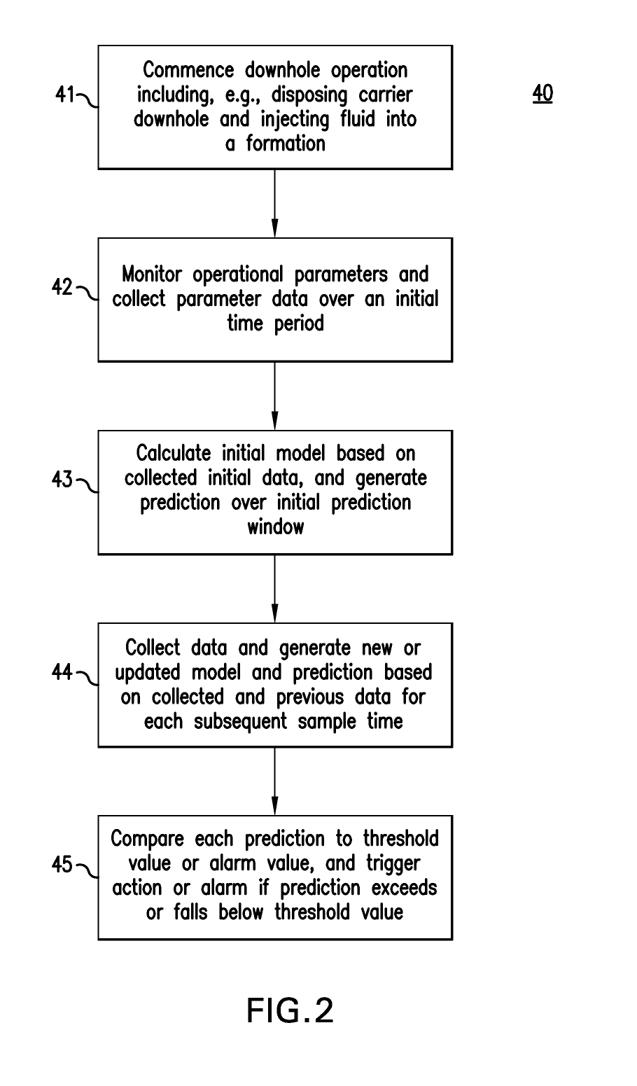

FIG. 1 illustrates aspects of an exemplary embodiment of a system 10 for hydrocarbon production and/or evaluation of an earth formation 12. The system 20 includes a borehole string 14 disposed within a borehole 16. The string 14, in one embodiment, includes a plurality of string segments or is a continuous conduit such as a coiled tube. As described herein, “string” refers to any structure or carrier suitable for lowering a tool or other component through a borehole or connecting a drill bit to the surface, and is not limited to the structure and configuration described herein. The term “carrier” as used herein means any device, device component, combination of devices, media and/or member that may be used to convey, house, support or otherwise facilitate the use of another device, device component, combination of devices, media and/or member. Exemplary non-limiting carriers include casing pipes, wirelines, wireline sondes, slickline sondes, drop shots, downhole subs, BHA's and drill strings.

In one embodiment, the system 10 is configured as a hydraulic stimulation system. As described herein, “stimulation” may include any injection of a fluid into a formation. A fluid may be any flowable substance such as a liquid or a gas, or a flowable solid such as sand. In this embodiment, the string 14 includes a stimulation assembly 18 that includes one or more tools or components to facilitate stimulation of the formation 12. For example, the string 14 includes a fracturing assembly 20, such as a fracture or “frac” sleeve device, and/or a perforation assembly 22. Examples of the perforation assembly 24 include shaped charges, torches, projectiles and other devices for perforating the borehole wall and/or casing. The string may also include additional components, such as one or more isolation or packer subs 24.

One or more of the stimulation assembly 18, the fracturing assembly 20, the perforation assembly 22 and/or packer subs 24 may include suitable electronics or processors configured to communicate with a surface processing unit and/or control the respective tool or assembly.

An injection system 26 includes an injection device such as a high pressure pump 28 in fluid communication with a fluid tank 30 or other fluid source. The pump 28 injects fluid into the string 14 to introduce fluid into the formation 12, for example, to stimulate and/or fracture the formation 12. The pump 28 may be located downhole or at a surface location.

One or more flow rate and/or pressure sensors 32 are disposed in fluid communication with the pump 28 and the string 14 for measurement of fluid characteristics. The sensors 32 may be positioned at any suitable location, such as proximate to (e.g., at the discharge output) or within the pump 28, at or near the wellhead, or at any other location along the string 14 or the borehole 16. The sensors described herein are exemplary, as various types of sensors may be used to measure various parameters.

A processing and/or control unit 34 is disposed in operable communication with the sensors 32 and the pump 28. The processing and/or control unit is configured to receive, store and/or transmit data generated from the sensors 32 and/or the pump 28, and includes processing components configured to analyze data from the pump 28 and the sensors, provide alerts to the pump 28 or other control unit and/or control operational parameters. The processing and/or control unit 34 includes any number of suitable components, such as processors, memory, communication devices and power sources.

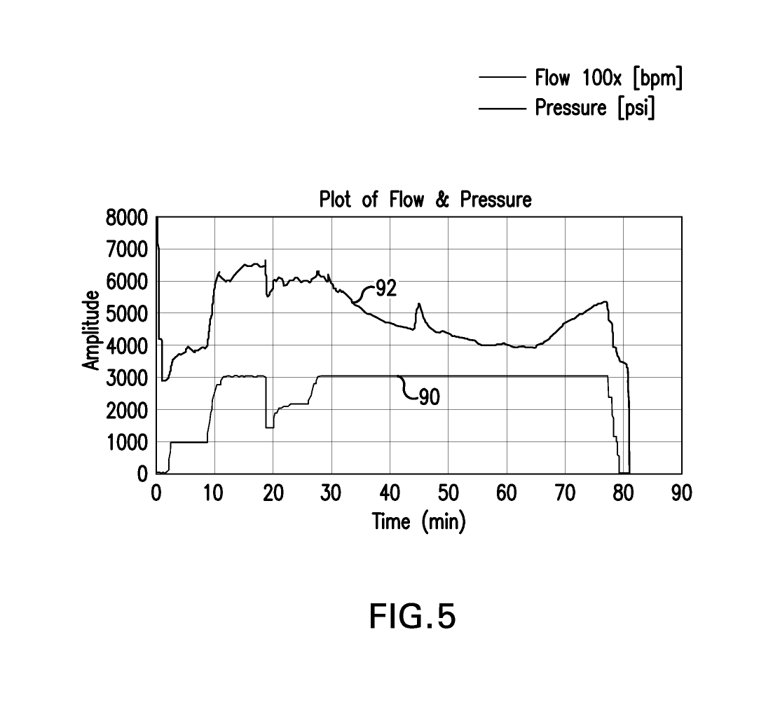

FIG. 5 provides an exemplary method 40 for analyzing received data. The method 50 may be used in conjunction with the system 10, but may also be used with any suitable apparatus or system for performing downhole operations that utilize real time or near real time measurements. In one embodiment, the method 40 includes the execution of all of stages 41-45 in the order described. However, certain stages may be omitted, stages may be added, or the order of the stages changed.

In the first stage 41, a downhole operation is commenced. For example, a stimulation operation is commenced by activating the pump 28 and pumping fluid into the borehole 16.

In the second stage 42, operational parameters are monitored for an initial selected time period. For example, the processing unit 34 receives flow rate and pressure signals from the sensors 32 and records flow rate and pressure measurements (i.e., samples) for a selected number of initial sample times.

In one embodiment, parameters are sampled over a time period at a selected sampling rate (e.g., samples per second). This rate can be selected, e.g., by an operator. An exemplary sampling rate for a stimulation operation is about 1-10 samples per second, which is usually sufficient for detecting overpressure events, although higher sampling rates can be used if desired.

In the third stage 43, an initial model is calculated based on all or a portion of the measurement data (also referred to as “initial data” or “initial samples”) taken during the initial time period. For example, the processing unit 34 uses all or a portion of the initial samples as input into a modeling algorithm to generate the initial model. The model is projected over a selected prediction time period or prediction window to predict the pressure and/or flow rate progression. The prediction window is an interval of time beginning at the end of the initial time period, and having a duration during which the model's prediction is considered to provide a reasonably accurate estimate of future behavior. Any suitable models can be used, including linear and non-linear models where appropriate. Examples of suitable non-linear models include Wiener models, neural networks, Recursive non-linear autoregressive models in general (RNAR), non-linear autoregressive moving average models with exogenous input (NARMAX) and output error (OE) polynomial models. Examples of suitable linear models include autoregressive moving average models with exogenous input (ARMAX), autoregressive models with exogenous input (ARX) and state space models.

In one embodiment, the model includes a threshold value, also referred to as an “alarm level”, which includes a maximum and/or minimum data value at which an alarm, warning or other action is triggered. For example, an alarm or other indication is provided to a control unit and/or a user to allow for remedial action to be taken. In one embodiment, the alarm level can directly trigger remedial action, e.g., the processing unit 34 can be triggered to take appropriate action and adjust operational parameters (e.g., change pump pressure or shut down pump). The alarm level, e.g., a pressure level, can be set by an operator to trigger an alarm, action or shut down event.

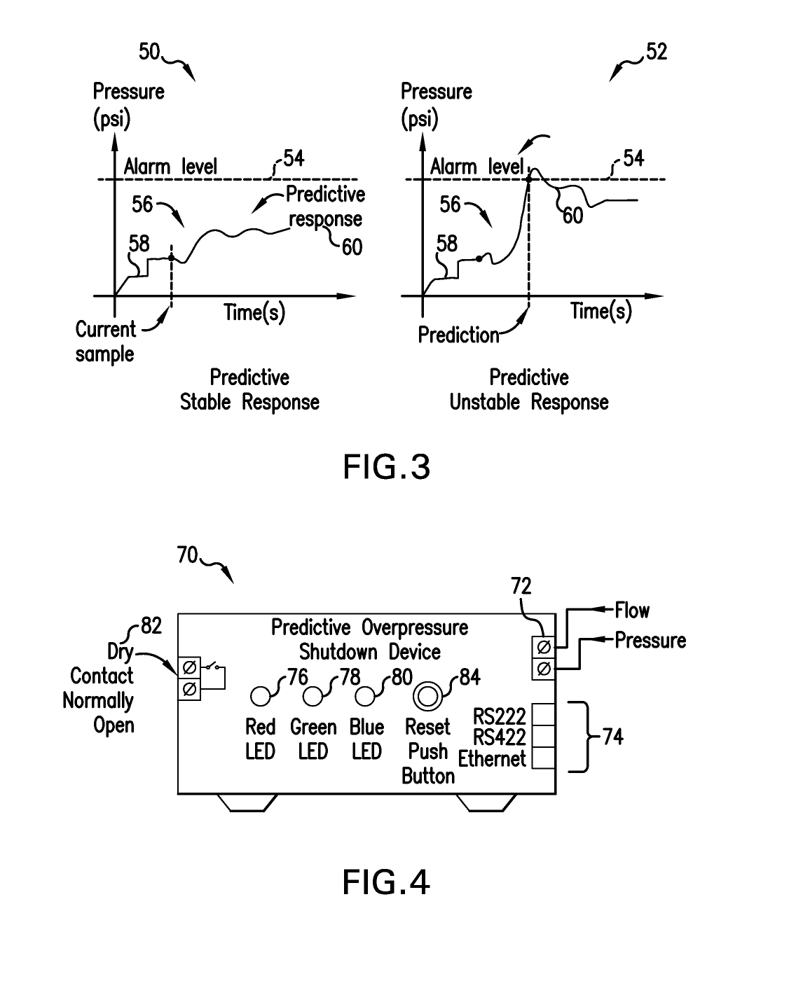

FIG. 3 illustrates embodiments of a model that may be utilized in the method 40. In these embodiments, the model is a recursive model, although the type of model that can be used is not so limited. The recursive model yields a curve that can indicate if the pressure will become stable at future times or is expected to rise and at what rate. FIG. 3 includes a first model 50 and a second model 52, each of which include an alarm level 54 and a curve 56. Each curve 56 includes a portion 58 that is generated based on measurement data that has already been collected, and a predictive portion or prediction 60 generated by the model based on the measurement data. As shown in FIG. 3, the model 50 includes a prediction that the pressure will remain stable over the prediction time period. The model 52 shows an unstable prediction, in which the pressure is predicted to exceed the alarm level 54. Such recursive models are capable of predicting a parameter rise event exceeding the alarm level in a shorter time than other models, such as linear trend analysis models that are typically used to predict future pressure values.

An exemplary non-limiting model algorithm is described in conjunction with equations (1) and (2) below. This algorithm uses sampled pressure and flow rate measurements (form, e.g., sensors 32) as inputs, although other data values could be used and the equations modified accordingly. For this model, it is assumed that pressure is a function of flow, i.e., Pressure=f (Flow). Pressure values are denoted as y(t) and flow rate values are denoted as x(t).

The identification problem can be set up using Least-Squares to find a Z-transform transfer function of the sampled flow rate and pressure measurements. The transfer function in the Z-transform domain is as follows:

$$\frac{Y ( z )}{X ( z )} = \frac{{a}_{0} + {a}_{1} {z}^{- 1} + {a}_{2} {z}^{- 2} + … {a}_{( n - 1 )} {z}^{- ( n - 1 )}}{{b}_{0} + {b}_{1} {z}^{- 1} + {b}_{2} {z}^{- 2} + … {b}_{n} {z}^{- n}} , \qquad ( 1 )$$

where a₀ . . . a₍ₙ₋₁₎ are coefficients for a difference equation for pressure, and b₀ . . . b₍ₙ₋₁₎ are coefficients for a difference equation for flow rate.

The next algorithm task is to convert from Z-domain to discrete time. The Z-transform is taken to give a solution for pressure y(k), where k is a number of discrete time values:

$$y ( k ) {b}_{0} = {x}_{k} {a}_{0} + {x}_{( k - 1 )} {a}_{1} {z}^{- 1} + … {x}_{( k - ( n - 1 ) n} {a}_{( n - 1 )} {z}^{- ( n - 1 )} - {y}_{( k - 1 )} {b}_{1} {z}^{- 1} - … {y}_{( k - n )} {b}_{n} {z}^{- n} \\ y ( k ) = {x}_{k} \frac{{a}_{0}}{{b}_{0}} + {x}_{( k - 1 )} \frac{{a}_{1}}{{b}_{0}} {z}^{- 1} + … {x}_{( k - ( n - 1 ) )} \frac{{a}_{( n - 1 )}}{{b}_{0}} {z}^{- ( n - 1 )} - {y}_{( k - 1 )} \frac{{b}_{1}}{{b}_{0}} {z}^{- 1} - … {y}_{( k - n )} \frac{{b}_{n}}{{b}_{0}} {z}^{n} . \qquad ( 2 )$$

These equations may be used by a processor (e.g., the processing unit 34) such as a digital computer, digital signal processor (DSP) or a fast microcontroller. These equations may be used to generate coefficients and plot the initial model.

In the fourth stage 44, measurement data is collected for a plurality of subsequent time periods, referred to herein as sample times. For each subsequent sample time, a new model is generated (or the current model is updated) using previously collected data, which includes data collected during the initial time period, data collected for the current sample time, and data collected for each previous sample time. Each new model includes a prediction over a selected time window starting at the current sample time. For example, the model shown in equation (2) is plotted once for each sample time to generate coefficients and yield a new predictive model at each sample time.

In one embodiment, previously collected or sampled data is used to verify that the new model is proper and can be used. This verification can be performed after each model is created or updated, and prior to providing predictions. The number of past samples to be used for verification can be any selected number, e.g., an operator can preset how many past samples are to be used for verification.

In the fifth stage 45, at each sample time, the updated or newly plotted model is analyzed over the prediction time period and compared to the alarm value. If the model is predicted to meet or exceed the alarm value during the prediction time period, an alarm and/or remedial action is triggered. In one embodiment, analysis of the model is performed upon receiving data for a sample time period and prior to receiving data for the next following time sample, so that predictions can be performed, and alarms generated, on a real time or near real time basis.

The alarm level and triggering mechanism is not limited to that described herein. Various alarm levels may be used and modified over the course of the operation based on operating conditions. In one embodiment, a sensitivity level can be set to mandate a number of times that the prediction hits the alarm level before an alarm or action is triggered.

The prediction time period or prediction window is also not limited to those described herein. Any suitable prediction horizon can be selected. For example, in a typical stimulation operation, a prediction window of between about 10 seconds and about 50 seconds can be selected.

In one embodiment, the processor (e.g., the processing unit 34) is configured to transmit model data (including the data modeled over the current time period and/or the prediction) to an external or remote processor for plotting, analysis, operational control and/or data logging. For example, the processor transmits the model's coefficients to an external PC for plotting, analysis, remote PC control and data logging purposes.

The method 40 may be used to analyze data and control an operation using such analysis. For example, the method 40 may be used in conjunction with a downhole operation, such as a measurement, stimulation or drilling operation, but is not so limited. The method can be used with any type of downhole or surface operation that can benefit from predictive data monitoring.

For example, the method can be used to facilitate a downhole stimulation operation, in which fluid is pumped and/or circulated in a borehole. During the operation, parameters such as pressure and flow rate are sampled and models are repeatedly generated and/or updated at each consecutive sample time (using the same modeling algorithm) over the course of the operation. At each sample time, if no “bad event,” such as an overpressure event, is predicted, the operation proceeds normally and fluid is injected as previously directed by an operator or controller. However, if a model generated at some sample time predicts a bad event within a prediction window, a processor or well sensor communicates to a pump or pump controller that a bad event is arriving and predicts its future impact.

The pump or pump controller, in response to the communication, prepares for the event arrival and makes operational corrections. For example, the pump may reduce the current flow rate or commence a shutdown procedure. Other actions and/or communications can be performed in response to the bad event. For example, other safety components can be activated, such as a blowout preventer. After the bad event is dealt with, the operation may continue or re-commence, and the processor continues monitoring and predicting future events.

FIG. 4 shows an exemplary pump control monitoring and/or control device 70. The device 70 includes input ports 72 for receiving flow and pressure data from a sensor, pump or pump controller, and output ports 74 for transmitting alarms or other communications to the pump or a pump controller. FIG. 4 shows exemplary indicators that can be used to facilitate operation of the device 70 and the modeling and prediction methods described herein.

For example, at power on and other instances when there is no active model, a first indicator 76 (e.g., a red LED) will turn ON and samples are collected for an initial time period. For example, data is collected for 60 sample times (which would translate to an initial time period of 60 seconds for a one-second sample time). A model is created and checked with data collected for the initial time period (e.g., the last 60 samples). If the model is valid, the red LED indicator 76 is turned OFF and a second indicator 78 (e.g., a green LED) will start blinking, which indicates that a model is active and the system is monitoring selected alarm levels. From this point on, at each time after a sample is taken, the model is recursively updated and checked again to verify that is a proper model, and if the model is proper, a prediction is made over a given horizon checking if an overpressure event is coming. If by any chance a model is checked that is not proper, the green LED indicator 78 stops blinking and remains ON indicating that the device 70 is still operating but with a non-updated model. As soon as a new model is created and found to be proper, the green LED indicator 78 starts blinking again.

When an alarm point is detected within the given horizon, a third indicator 80 (e.g., a blue LED) starts blinking to indicate that a rising overpressure event is detected. When the blue LED indicator 80 is turned ON, a dry contact 82 may also be activated. At this point, both the blue LED indicator 80 and the dry contact 82 are latched ON to send an alarm indication or control command to the pump or pump controller, until a reset command is send to the device 70 or a Reset button 84 is manually depressed.

FIGS. 5-11 demonstrate the functionality of the systems and methods described herein to predict real-time pressure changes in a borehole when driven with an influx on fracturing operations, allowing early pump speed adjustments or pump shutdown. The measurement data shown in FIGS. 5-11 was collected from downhole stimulation operations and is used to simulate the modeling and prediction operations described above.

In the examples described below, data points (flow and pressure) or samples are taken at time intervals of one second. After calculation of an initial model, at each interval or sample time (i.e., every second), a data point is fed to a processor (e.g., the processing unit 34 or device 70) and a new model is calculated using previously collected data. A new model is calculated at each second, thus the lifetime of each model is one second. It is noted that the sample time of one second for which each model is calculated may be different than the actual measurement sampling rate, which may be on the order of tens of samples per second. Various models can predict over a wide range of time, e.g., the method described in conjunction with FIGS. 5-11 is expected to be useful for prediction windows of about one second to about one minute, which can be adjusted as a sensitivity adjustment. For the operations described in conjunction with FIGS. 5-11, about ten seconds to about one minute is typically long enough to adjust pump speeds.

FIG. 5 shows flow rate and pressure data as a flow rate curve 90 and a pressure curve 92, for a stimulation job that was performed over an approximate 80-minute period. Flow rate values have been scaled up to 100× for clarity purposes in all plots shown in FIGS. 5-11. The measurements in these examples were taken by surface sensors. If measurements are taken at downhole locations, formation parameters can also be identified as part of the methods described herein.

Various stages of the method 40 are shown, and calculated models are shown at selected sample times. The full response for the captured models is plotted against the original data to evaluate the model's prediction starting from the time at which each model is created (the critical-point) to the full extent of the simulation.

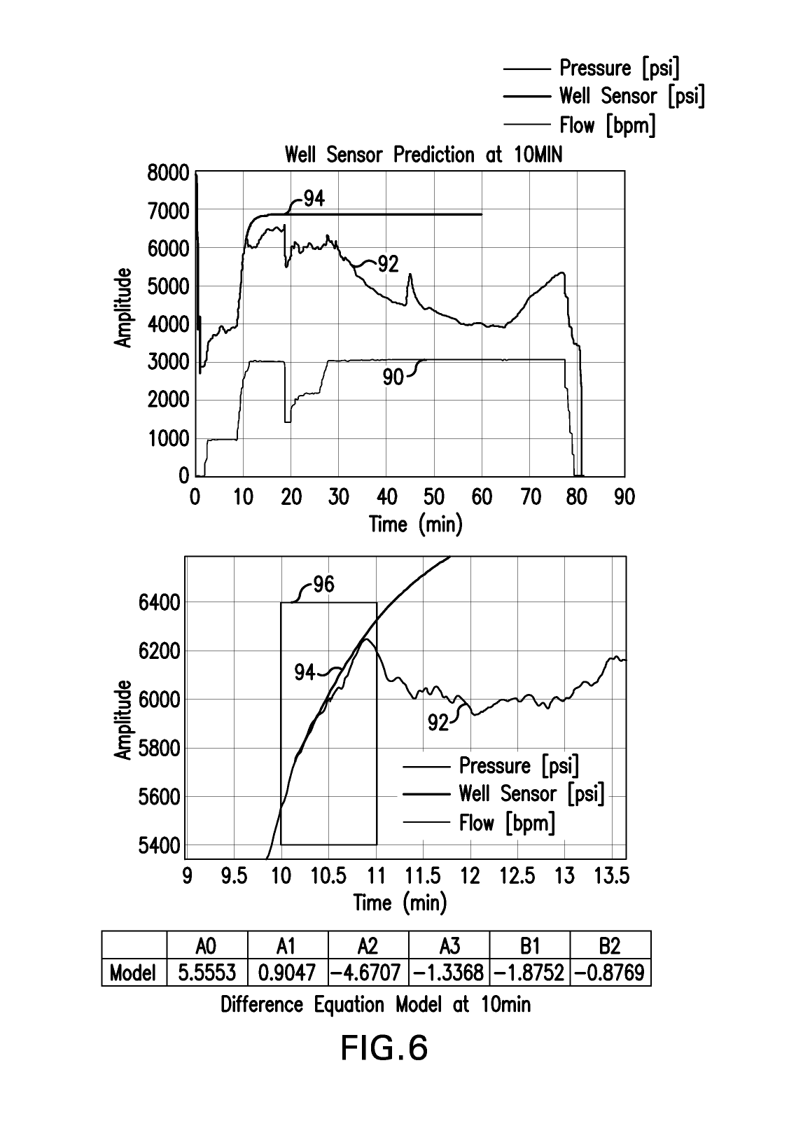

FIG. 6 is a snapshot of the flow rate curve 90, the pressure curve 92 and a model 94 calculated at the 10-minute sample time. The input flow is locked at this time and the model is calculated using equation (2) and the flow and pressure data points from zero to 10 minutes. The model 94 shows the predicted response assuming the input flow is held constant at the locked value. As is evident in FIG. 6 the prediction corresponds well with the pressure curve 92 over a prediction window 96 of between about one second and about one minute, and thus the prediction is assumed valid over this window. FIG. 6 also shows the coefficients calculated for the model at the 10-minute sample time.

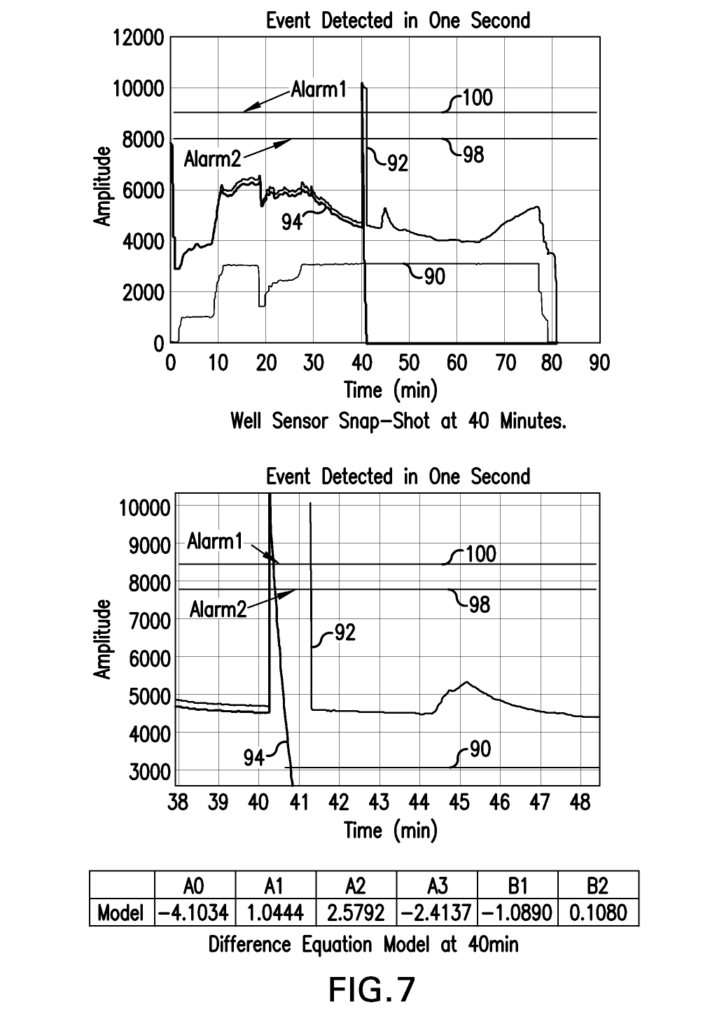

FIG. 7 shows the same measurement data as that of FIGS. 5-6, with the addition of a pressure peak at around 40 minutes. The pressure peak in this example is a pressure step to about 10,000 psi with a 90 degree slope. In this example, alarm levels 98 and 100 are set at 8,000 psi and 10,000 psi, respectively. The model 94 in this example is calculated at one second after the pressure peak is applied. As shown, the model 94 generates a peak that exceeds both alarm levels 98 and 100, which causes alarms to be set off immediately. As can be seen from FIG. 7, the pressure step was easily detected.

It is noted that the alarms or triggers can be modified or enabled/disabled by an operator if the model overreacts to pressure changes or if certain pressure changes are to be disregarded.

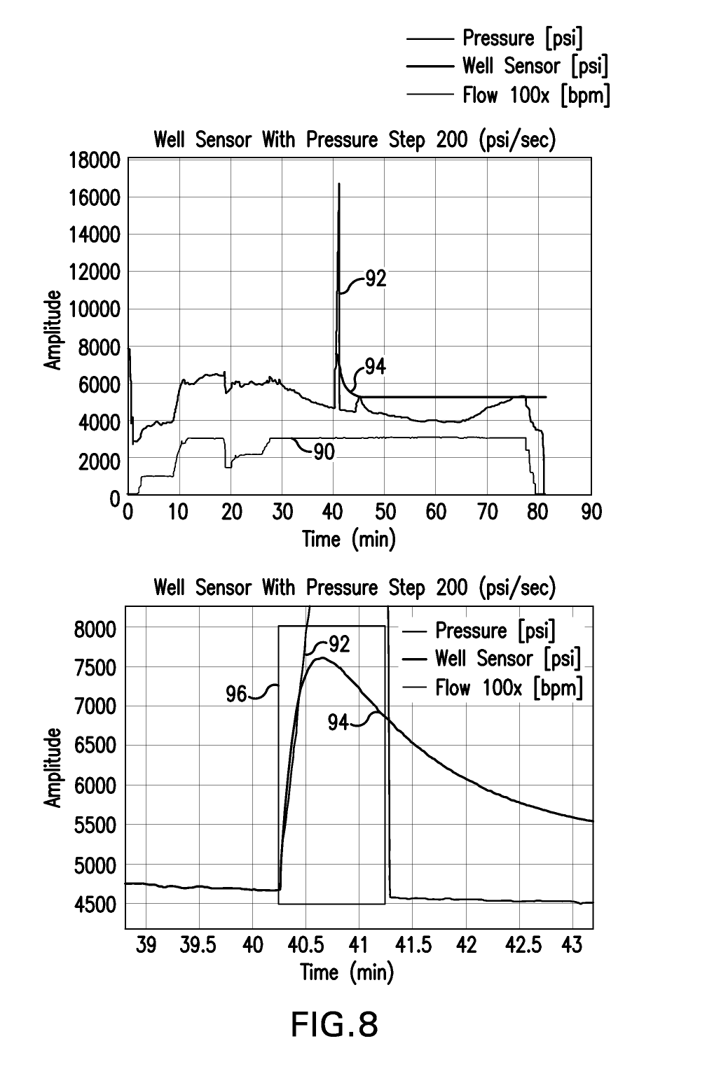

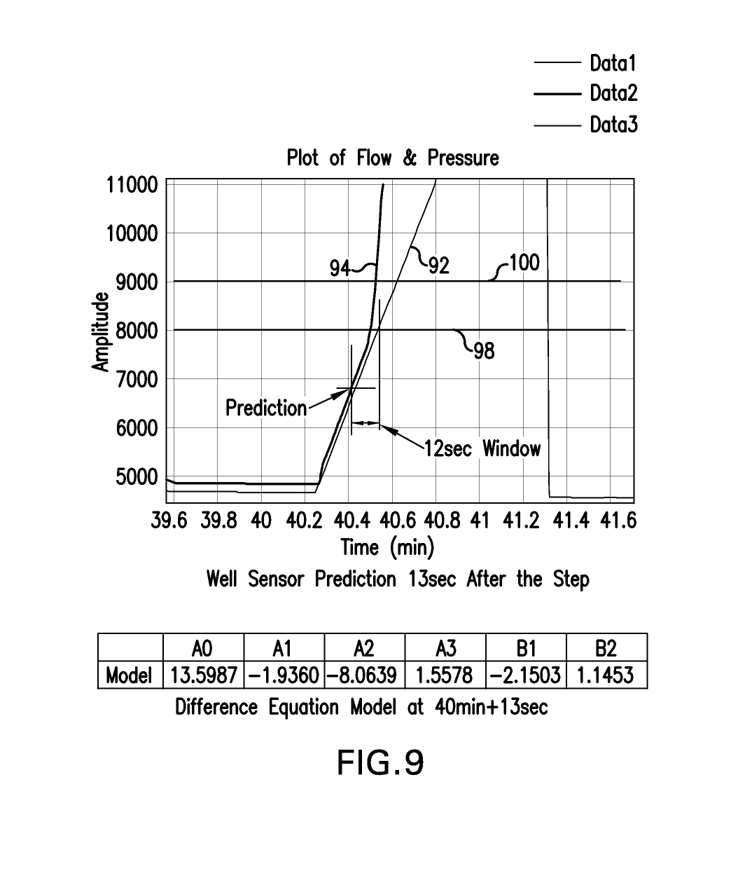

FIGS. 8 and 9 show an example of the model 94 for a pressure increase or pressure step or peak that has a time slope. In this example, the pressure curve 92 has a pressure step at 40 minutes that increases at a rate of 200 psi per second. FIG. 8 shows the model as calculated at the initiation of the pressure step. FIG. 9 shows the model 94 calculated 13 seconds after the pressure step initiates.

At the sample time shown in FIG. 9, the prediction window is 12 seconds. “Prediction window” refers to the amount of time that elapses between the current sample time and the time at which the model is predicted to cross an alarm level, which in this instance is both alarm levels 98 and 100. The model 94 shows the pressure crossing the alarm level prior to the actual pressure exceeding the alarm level. Thus, in this example, the model provides a window of at least 12 seconds for the pump to respond, which is typically sufficient in stimulation operations.

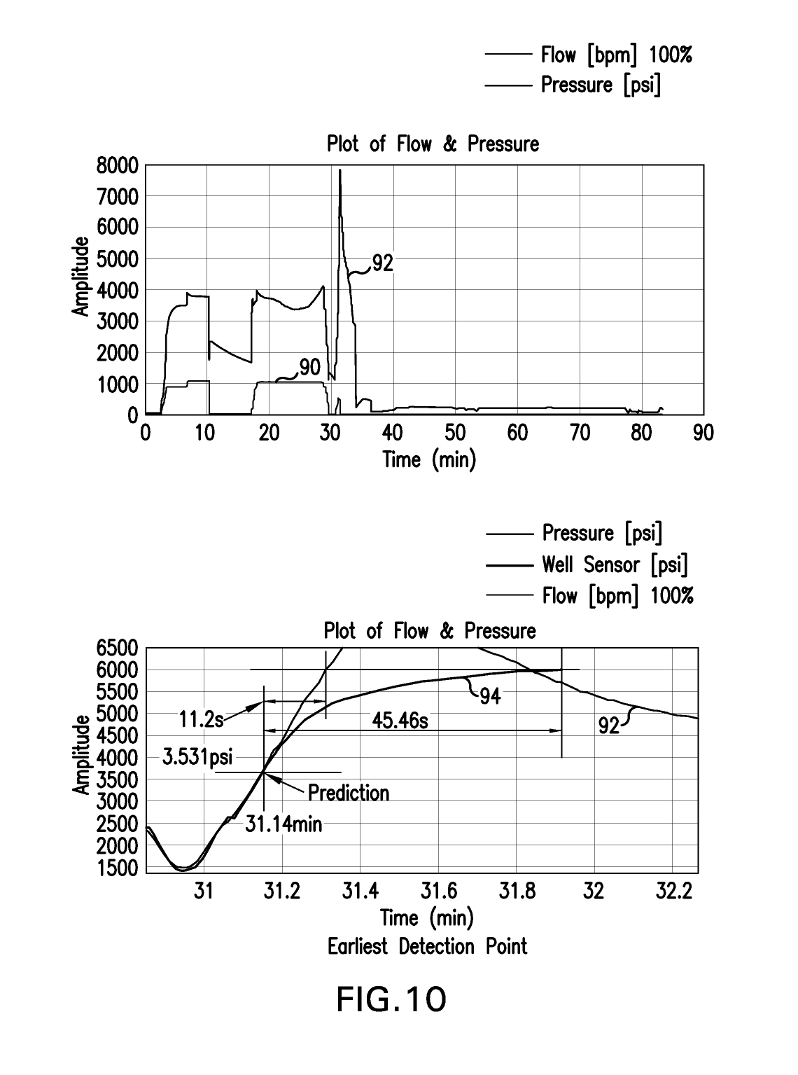

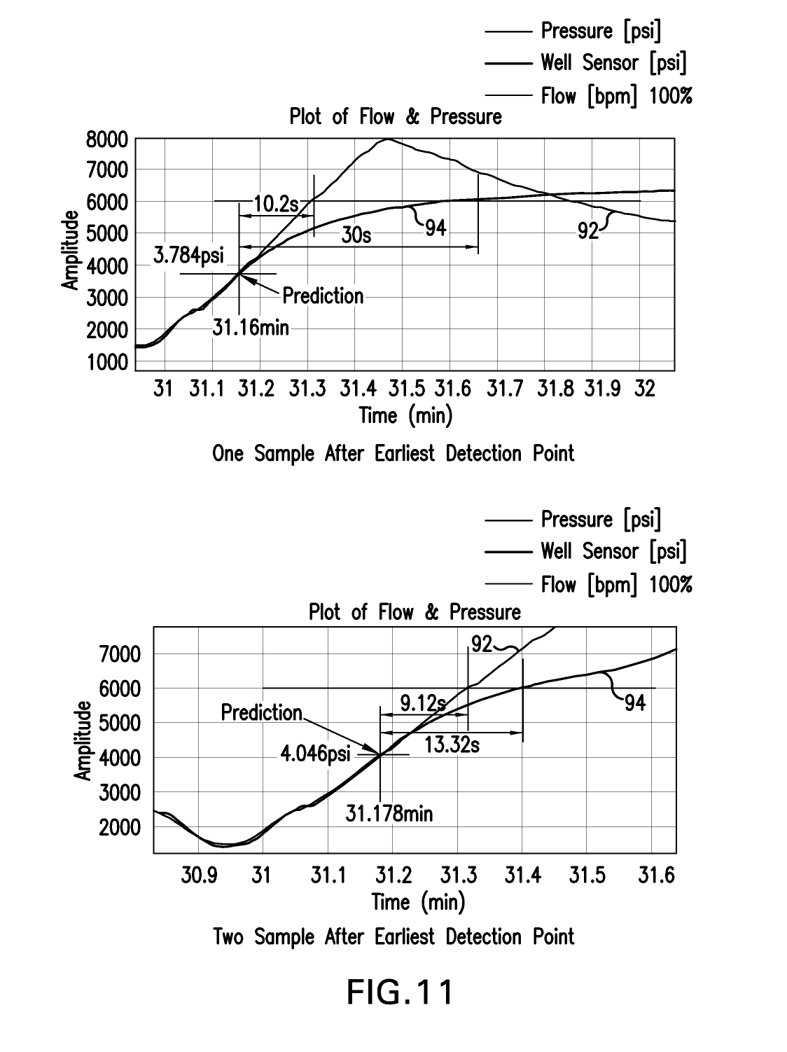

FIGS. 10 and 11 show another example, which demonstrates both an earliest overpressure detection time as well as how the prediction changes as the time approaches the actual overpressure event. In this example, the alarm level is set at 6,000 psi. FIG. 10 shows the earliest time sample at which overpressure is detected, which is located at 31.14 minutes with a pressure of 3,531 psi. At this time sample, the prediction window is found by the model to be 45.46 seconds. Although the actual overpressure occurs at 11.2 seconds after this time sample, 11.2 seconds is sufficient to shutdown the system or take other remedial action.

FIG. 11 demonstrates how the prediction accuracy increases as new models 94 are iteratively calculated at each subsequent time sample. For example, at the immediately following time sample (t=31.16 minutes), the prediction window is 30 seconds whereas the actual overpressure time is 10.2 seconds. At the next time sample, the prediction window is 13.32 seconds whereas the overpressure time is 9.12 seconds. Thus, the prediction accuracy increases substantially after only two time samples. It is noted that, at each of the above time samples of FIGS. 13 and 14, the prediction model provides sufficient time for the system to react to an impending pressure increase.

It is noted that the types and applications of the models are not limited to those described herein. In addition to pressure and flow rate, various parameters and types of measurements can be used. For example, downhole operations can encompass many types of measurements and measurement parameters. Examples of measurements include resistivity, nuclear magnetic resonance (NMR), acoustic, seismic, nuclear (e.g., pulsed neutron, gamma sources, and the like) as well as other such technologies. Parameters associated with various aspects of formations and/or features may be used. Exemplary parameters include, for example, density, temperature, pressure, porosity, isotopic identity, chemical composition, pH, conductivity, resistivity, stress, strain and the like. Other exemplary parameters include tool-related parameters such as temperature, vibration, tool wear and remaining useful life parameters.

A number of benefits result from implementation of the methods and apparatuses disclosed herein. For example, the methods and apparatuses provide an effective way to detect impending over pressure events or other conditions that require some form of remedial action or warning. Substantially continuous, updated predictions can be generated at real time or near-real time to facilitate early detection of events.

In support of the teachings herein, various analysis components may be used, including a digital system and/or an analog system. The system 10 and/or other devices such as the device 70, processing unit 34, sensors 32 and/or the pump 28 may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of monitoring and predicting measurement data, comprising:
collecting a first plurality of measured data values over an initial time interval;
calculating an initial predictive model based on the initial measured data values collected during the initial time interval, and calculating a prediction of data values over a prediction time window beyond the initial time interval based on the initial predictive model;
collecting a second plurality of measured data values at a plurality of time values following the initial time interval;
for each of the second plurality of time values, calculating a new predictive model based on: a current measured data value at a current time value, the first plurality of measured data values, and measured data values associated with time values between the current time value and the initial time interval; and
for each of the second plurality of time values, calculating a prediction of data values over a prediction time window beyond the current time value based on the new predictive model.

2. The method of claim 1, wherein the first and second pluralities of measured data values are collected in real time for a plurality of consecutive time intervals over the course of an operation.

3. The method of claim 1, wherein the first and second pluralities of measured data values are collected via a sensor device during a downhole operation.

4. The method of claim 1, wherein the initial predictive model and the new predictive models are recursive models.

5. The method of claim 1, wherein calculating the prediction includes comparing the prediction to at least one threshold value within the prediction time window.

6. The method of claim 5, further comprising taking a remedial action in response to the prediction exceeding or falling below the at least one threshold value within the prediction time window.

7. The method of claim 1, wherein the first and second pluralities of measured data values are collected during a downhole operation that includes injection of fluid into a borehole, the measured data values including fluid pressure values and flow rate values.

8. The method of claim 7, wherein the model is calculated using an algorithm that includes:
performing a Z-transform of pressure values y(t) and flow rate values x(t) using the following transfer function:
$$\frac{Y ( z )}{X ( z )} = \frac{{a}_{0} + {a}_{1} {z}^{- 1} + {a}_{2} {z}^{- 2} + … {a}_{( n - 1 )} {z}^{- ( n - 1 )}}{{b}_{0} + {b}_{1} {z}^{- 1} + {b}_{2} {z}^{- 2} + … {b}_{n} {z}^{- n}} ,$$
wherein a₀ . . . a₍ₙ₋₁₎ are coefficients for a difference equation for pressure, and b₀ . . . b₍ₙ₋₁₎ are coefficients for a difference equation for flow rate; and
converting the transfer function into a discrete time function of pressure y(k) represented by:
$$y ( k ) {b}_{0} = {x}_{k} {a}_{0} + {x}_{( k - 1 )} {a}_{1} {z}^{- 1} + … {x}_{( k - ( n - 1 ) n} {a}_{( n - 1 )} {z}^{- ( n - 1 )} - {y}_{( k - 1 )} {b}_{1} {z}^{- 1} - … {y}_{( k - n )} {b}_{n} {z}^{- n}$$
$$y ( k ) = {x}_{k} \frac{{a}_{0}}{{b}_{0}} + {x}_{( k - 1 )} \frac{{a}_{1}}{{b}_{0}} {z}^{- 1} + … {x}_{( k - ( n - 1 ) )} \frac{{a}_{( n - 1 )}}{{b}_{0}} {z}^{- ( n - 1 )} - {y}_{( k - 1 )} \frac{{b}_{1}}{{b}_{0}} {z}^{- 1} - … {y}_{( k - n )} \frac{{b}_{n}}{{b}_{0}} {z}^{n} ,$$
wherein k is a number of discrete time values.

9. The method of claim 7, wherein calculating the prediction includes comparing the prediction over the prediction time window with at least one threshold pressure value representing an overpressure event, and performing a remedial action in real time in response to detecting that the prediction equals or exceeds the at least one threshold pressure value.

10. The method of claim 9, wherein the remedial action includes at least one of transmitting an alarm, adjusting operational parameters and commencing a shutdown procedure.

11. An apparatus for monitoring and predicting measurement data, comprising:
at least one sensor configured to measure a parameter; and
a processor configured to collect a first plurality of measured data values over an initial time interval and collect a second plurality of measured data values at a plurality of time values following the initial time interval, the processor configured to perform:
calculating an initial predictive model based on the initial measured data values collected during the initial time interval, and calculating a prediction of data values over a prediction time window beyond the initial time interval based on the initial predictive model;
for each of the second plurality of time values, calculating a new predictive model based on: a current measured data value at a current time value, the first plurality of measured data values, and measured data values associated with time values between the current time value and the initial time interval; and
for each of the second plurality of time values, calculating a prediction of data values over a prediction time window beyond the current time value based on the new predictive model.

12. The apparatus of claim 11, wherein the first and second pluralities of measured data values are collected in real time for a plurality of consecutive time intervals over the course of an operation.

13. The apparatus of claim 11, wherein the at least one sensor is configured to measure parameters during a downhole operation.

14. The apparatus of claim 11, wherein the initial predictive model and the new predictive models are recursive models.

15. The apparatus of claim 11, wherein calculating the prediction includes comparing the prediction to at least one threshold value within the prediction time window.

16. The apparatus of claim 15, wherein the processor is configured to take a remedial action in response to the prediction exceeding or falling below the at least one threshold value within the prediction time window.

17. The apparatus of claim 11, wherein the first and second pluralities of measured data values are collected during a downhole operation that includes injection of fluid into a borehole, the measured data values including fluid pressure values and flow rate values.

18. The apparatus of claim 17, wherein the model is calculated using an algorithm that includes:
performing a Z-transform of pressure values y(t) and flow rate values x(t) using the following transfer function:
$$\frac{Y ( z )}{X ( z )} = \frac{{a}_{0} + {a}_{1} {z}^{- 1} + {a}_{2} {z}^{- 2} + … {a}_{( n - 1 )} {z}^{- ( n - 1 )}}{{b}_{0} + {b}_{1} {z}^{- 1} + {b}_{2} {z}^{- 2} + … {b}_{n} {z}^{- n}} ,$$
wherein a₀ . . . a₍ₙ₋₁₎ are coefficients for a difference equation for pressure, and b₀ . . . b₍ₙ₋₁₎ are coefficients for a difference equation for flow rate; and
converting the transfer function into a discrete time function of pressure y(k) represented by:
$$y ( k ) {b}_{0} = {x}_{k} {a}_{0} + {x}_{( k - 1 )} {a}_{1} {z}^{- 1} + … {x}_{( k - ( n - 1 ) n} {a}_{( n - 1 )} {z}^{- ( n - 1 )} - {y}_{( k - 1 )} {b}_{1} {z}^{- 1} - … {y}_{( k - n )} {b}_{n} {z}^{- n}$$
$$y ( k ) = {x}_{k} \frac{{a}_{0}}{{b}_{0}} + {x}_{( k - 1 )} \frac{{a}_{1}}{{b}_{0}} {z}^{- 1} + … {x}_{( k - ( n - 1 ) )} \frac{{a}_{( n - 1 )}}{{b}_{0}} {z}^{- ( n - 1 )} - {y}_{( k - 1 )} \frac{{b}_{1}}{{b}_{0}} {z}^{- 1} - … {y}_{( k - n )} \frac{{b}_{n}}{{b}_{0}} {z}^{n} ,$$
wherein k is a number of discrete time values.

19. The apparatus of claim 17, wherein calculating the prediction includes comparing the prediction over the prediction time window with at least one threshold pressure value representing an overpressure event, and performing a remedial action in real time in response to detecting that the prediction equals or exceeds the at least one threshold pressure value.

20. The apparatus of claim 11, wherein the processor is configured to transmit model data to an external processor for at least one of plotting, analysis, operational control and data logging.
